(19) United States
(12) Patent Application Publication
(10) Pub. No.: US 2013/0162670 A1
(43) Pub. Date: Jun. 27, 2013

(54) DYNAMIC CARD VIEW

(71) Applicants: Pradeep Kumar Singh, Azamgarh (IN); Hilmar Demant, Karlsdorf (DE)

(72) Inventors: Pradeep Kumar Singh, Azamgarh (IN); Hilmar Demant, Karlsdorf (DE)

(73) Assignee: SAP AG, Walldorf (DE)

(21) Appl. No.: 13/336,884

(22) Filed: Dec. 23, 2011

(51) Int. Cl. G09G 5/377

(52) U.S. Cl. 345/629

(57) ABSTRACT

A computer system includes at least one processor and a computer-readable storage medium that includes instructions executable by the at least one processor. The instructions implement a table having a linear collection of multiple primary objects, where each of the primary objects occupies a single row in the table and a table control module to create virtual intermediate row-level objects from the linear collection of multiple primary objects. The virtual intermediate row-level objects include a first subset of the primary objects linked to one or more other subsets of the primary objects in a virtual hierarchy using a binding mechanism. The instructions are configured to implement a card view module configured to generate a card view from the virtual intermediate row-level objects and to render a display of the card view having multiple cards in a single row, where each of the cards represents one of the multiple primary objects.

### TECHNICAL FIELD

This description relates to a dynamic card view.

### BACKGROUND

A large collection of objects (e.g., objects in a table or database) may present various challenges. For example, it may be challenging to maintain and display the large collection of objects in a desired manner and/or format. Also, current table-related features may make it possible to display only one primary object in a row, whereas this may not be sufficient to meet current display and view needs. Thus, it may be desirable to have systems and techniques that provide flexibility in displaying and viewing objects from a table or database.

### SUMMARY

According to one general aspect, a computer system includes at least one processor and a non-transitory computer-readable storage medium that includes instructions executable by the at least one processor. The instructions are configured to implement a table having a linear collection of multiple primary objects, where each of the primary objects occupies a single row in the table and a table control module configured to create virtual intermediate row-level objects from the linear collection of multiple primary objects. The virtual intermediate row-level objects include a first subset of the primary objects linked to one or more other subsets of the primary objects in a virtual hierarchy using a binding mechanism, where the first subset of primary objects is different from the other subsets of primary objects. The instructions are configured to implement a card view module configured to generate a card view from the virtual intermediate row-level objects and to render a display of the card view having multiple cards in a single row, where each of the cards represents one of the multiple primary objects.

In another general aspect, a non-transitory computer-readable storage medium stores instructions that when executed cause a processor to perform a process. The instructions include instructions to create virtual intermediate row-level objects from a table having a linear collection of multiple primary objects, where each of the primary objects occupies a single row in the table. The virtual intermediate row-level objects include a first subset of the primary objects linked to one or more other subsets of the primary objects in a virtual hierarchy using a binding mechanism, where the first subset of primary objects is different from the other subsets of primary objects. The instructions include instructions to generate a card view from the virtual intermediate row-level objects and to render a display of the card view having multiple cards in a single row, where each of the cards represents one of the multiple primary objects.

In another general aspect, a method includes executing instructions recorded on a non-transitory computer-readable storage media using at least one processor. The method includes creating virtual intermediate row-level objects from a table having a linear collection of multiple primary objects, where each of the primary objects occupies a single row in the table. The virtual intermediate row-level objects include a first subset of the primary objects linked to one or more other subsets of the primary objects in a virtual hierarchy using a binding mechanism, where the first subset of primary objects is different from the other subsets of primary objects. The method includes generating a card view from the virtual intermediate row-level objects and rendering a display of the card view having multiple cards in a single row, where each of the cards represents one of the multiple primary objects.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for generating and rendering a card view of objects.

FIG. 2 is a block diagram of an exemplary table having a collection of objects.

FIG. 3 is a block diagram of an exemplary table of virtual intermediate row-level objects.

FIG. 4 is an exemplary screen shot of a card view.

FIG. 5 is an exemplary screen shot of a card view.

FIG. 6 is a flowchart illustrating example operations of the system of FIG. 1.

### DETAILED DESCRIPTION

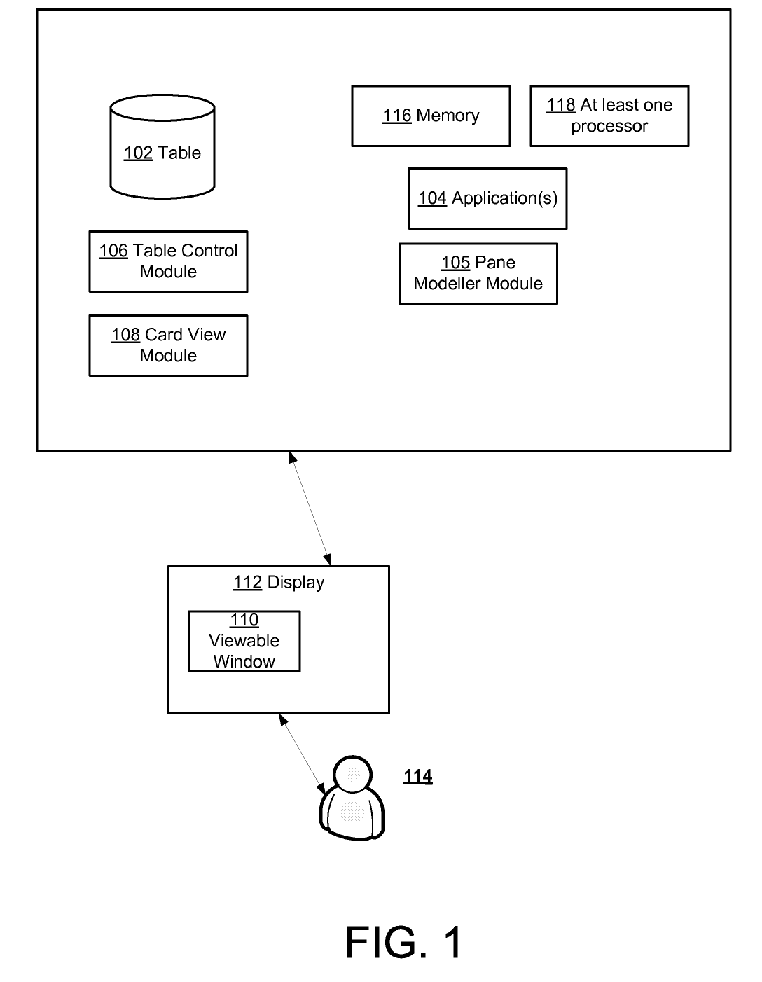

Referring to FIG. 1, an exemplary block diagram illustrates an exemplary system 100 for generating and rendering a card view of objects. The system 100 includes a table 102. The table 102 also may be interchangeably referred to as a database or a data store. The table 102 may include a collection of objects. The collection of objects may be arranged in a linear manner with each of the objects occupying a single row in the table 102. When each of the objects occupies a single row in the table, the objects may be referred to as primary objects.

The table 102 may include many objects. In one exemplary implementation, the table 102 may include thousands, tens of thousands, hundreds of thousands or more objects. The objects in the table 102 may represent any type of data or data list (e.g., business data, supply chain data, customer relationship data, human resources data. Also, for example, the objects may be a list of reports (e.g., expense reports), forms into which data may be input, pictures, other lists of data, maps, images or any other type of object.

In one exemplary implementation, the collection or list of objects may be related to each other. For example, the objects may be related by the type and/or the format of the object. The objects may includes one or more fields that are common to each other.

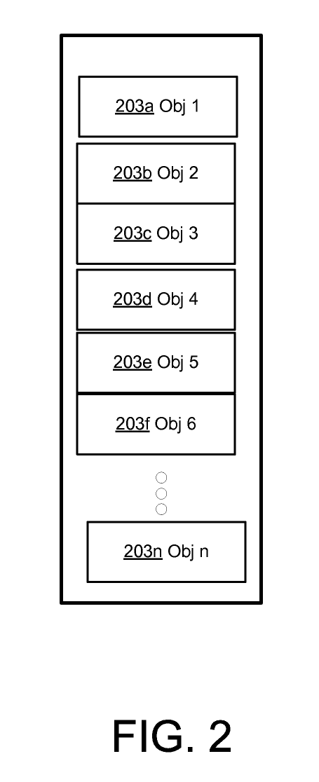

Referring also to FIG. 2, an exemplary block diagram illustrates an exemplary table 202. The exemplary table 202 is one example of the table 102 of FIG. 1. In this example, the table 202 includes a collection of multiple objects “Obj 1” through “Obj n” 203a-203n. The collection of multiple objects 203a-203n may include any number of objects (e.g., primary objects) arranged in a linear manner, where each of the objects occupies a single row in the table 202. As discussed above with respect to FIG. 1, the objects 203a-203n may be any type of object.

Referring back to FIG. 1, one implementation of the system 100 is to take a table of a linear collection of primary objects (e.g., table 202 with objects 203a-203n) and to render a card view display of the objects, where it is possible to display more than object in a same row. A card view is a user interface (UI) to visualize an object collection, where each object is visualized as a card. A card is a UI or a portion of a UI, which represents an object (or a data row). The system 100 is configured to transform the collection of linear objects in the table 102 into a card view, where each object is represented by a single card and more than one card may be rendered and displayed in the same row. In this manner, the cards representing the objects may be displayed in a multi-column format meaning that more than one primary object may be displayed per row in the displayed card view.

The card view is a defined view of the object as a card. Each object in the table 102 of objects may have its own card view. The card view is a flexible display format that may be designed and arranged in a configurable format. The card view may be designed in a format that is desired to display each instance in the collection of objects from the table. In one exemplary implementation, the card view may be a read-only view, where the card is for display only and no actions may be performed on the card.

In other exemplary implementations, the card view may be editable. For instance, the card view may includes actions that may be performed on the particular object through input by a user. For instance, the card view may be a form that may be edited through input by a user. The form may include input fields, drop down menus and other actions, including options to submit and/or to save the information. In one exemplary implementation, only the data that is input into the card may be communicated to a backend application such as, for example, application 104.

In some exemplary implementations, the application 104 may be, for example, a financial application, a business process application, a human resources application, an engineering application, a customer relations management application, a supply chain management application, and/or any other type of application. In some exemplary implementations, the application 104 may be an enterprise application or a suite of applications.

A card in a card view may be a modelled pane (e.g., a form pane) or a custom UI or a combination of a modelled pane and a custom UI. The card in the card view may be user-configurable meaning, for example, that a UI designer may model and pre-define the format and the layout using a pane modeller module 105. The pane modeller module 105 may include an application that allows for the modelling and design of the card view. While illustrated as part of the system 100, the pane modeller module 105 may be implemented as part of other systems that are specifically meant for the design and modelling of user interfaces, including cards in a card view.

The system 100 includes a table control module 106 and a card view module 108. The table control module 106 and the card view module 108 may work together in a coordinated manner to render a display of a card view of objects in table 102 in a viewable window 110 on a display 112 for a user 114. Although the table control module 106 and the card view module 108 are illustrated in the exemplary block diagram as separate modules, the table control module 106 and the card view module 108 may be implemented a single module.

The table control module 106 is operably connected to the table 102. The table control module 106 is configured to create virtual intermediate row-level objects from the linear collection of objects in the table 102. The table control module 106 may create the virtual intermediate row-level objects by creating subsets of the primary objects that are bound to each other in a virtual hierarchy using at least one binding mechanism. In this manner, the table control module 106 may have a first subset of primary objects that are in a first column. The table control module 106 may bind other subsets of the objects to the first subset of objects in subsequent columns (e.g., a second column, a third column, etc.) such that multiple objects may be generated and rendered in a same row of a card view. The table control module 106 is configured to transform the linear collection of objects into a multi-dimensional virtual format that enables a display of multiple objects as a card view in a single row, where each of the cards in the card view represents an object.

The card view module 108 may generate a card view of the objects from the virtual intermediate row-level objects and the subsets of objects that are virtually bound to one another. The card view module 108 may render a display of the card view having multiple cards in a single row. In one exemplary implementation, the display of the card view may be rendered in a viewable window 110 on a display 112. The display 112 may be operable coupled to the system 100. In other exemplary implementations, the viewable window 110 on the display 112 may be implemented on a computing device that is in communication with the system 100 over a network (e.g., a wired or wireless network) including a local area network (LAN) and/or a wide area network (WAN) such as the Internet.

The table control module 106 and/or the card view module 108 may receive inputs from the display 112 as to the current size of the viewable window 110. The number of cards that are rendered for display may be based on the size of the viewable window 110 and/or the size of the card for each object. As the size of the viewable window 110 dynamically changes (e.g., the user changes the size of the viewable window 110), the number of cards rendered for display in a same row changes dynamically. In this manner, the resizing of the viewable window 110 may dynamically cause a number of cards displayed in a single row to change.

In one exemplary implementation, the table control module 106 may determine the number of cards to fit in a row based on a size of the card and a size of the viewable window 110. For example, the table control module may use that size information to determine the number of cards per row and then divide the number of objects in the table 102 by the number of cards (or objects) per row to create the virtual intermediate row-level objects. The number of objects per row are each a subset of the total objects in the table 102. The first column of objects in the virtual intermediate row-level objects is a first subset of the objects and any subsequent columns are other subsets of the objects that are bound to the first subset of objects by a binding mechanism.

In one exemplary implementation, the table control module 106 may perform or use a binding expression calculation service. This service may automatically check for the parent context and if the control is being hosted in a card view, it calculates the binding expression such that the card view may be generated by the card view module 108. In one implementation, the calculated binding expression may be: CardColumn[n].DataObject<FieldName>, where the CardColumn refers to a subset of the objects for the row, n is the index of the card in the row and FieldName is an actual data field from the object.

In one exemplary implementation, the table control module 106 performs functions related to paging. For example, if the table request data for row n, then the request is transformed for object with index n*c and n*c+1 in the original collection, where c is the number of cards per row.

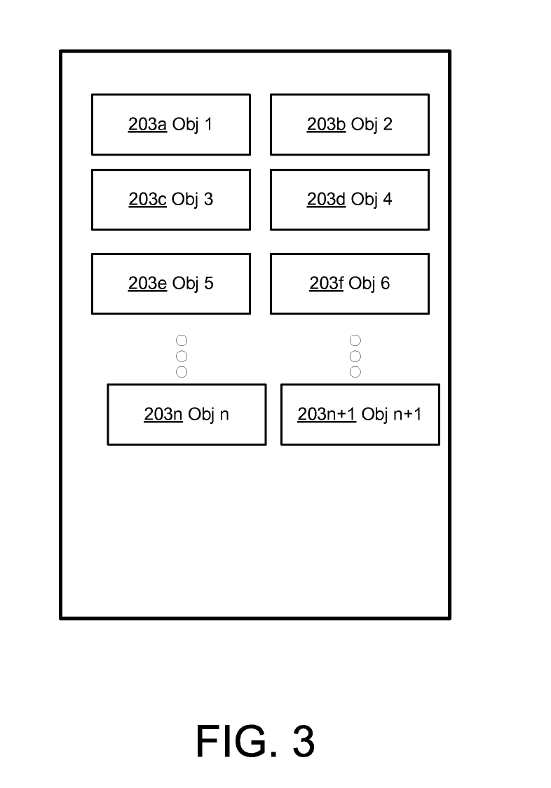

Referring to FIG. 3, a block diagram illustrates an exemplary table 350 of virtual intermediate row-level objects created by the table control module 106 from the table 202 of multiple objects 203a-203n of FIG. 2. To arrive at the table 350, the table control module 106 in conjunction with the card view module 108 determines the number of cards per row based on a size of the card to be used to visually represent the object in a card view and a size of the viewable window 110. In this example, it has been determined that two cards may be displayed per row. This also may be expressed as a two column card view. In other examples, the number of cards per row may be different.

The table control module 106 divides the objects by the number of cards per row and creates a first subset of the objects 203a, 203c, 203e and 203n and links a second subset of the objects 203b, 203d, 203f and 203n+1 to the first subset of objects to create a virtual hierarchy using a binding mechanism. The table 350 is not itself made visually available for display.

Instead, the card view module 108 generates a card view of the cards from the table 350 and displays two cards per row in the viewable window 110, where each of the cards represents one of the objects. The entire columns of cards may not fit in the viewable window 110 at a same time and may only be displayed as a user scrolls or moves in the viewable window. In one exemplary implementation, the card view module 108 is configured to generate the card view and render the display of the card view of only the cards capable of being displayed in the viewable window 110. In this manner, processing power and time are saved because only the cards that will be visually displayed need to be created and rendered for display. The card view module 108 dynamically creates and renders the card view based on input received through the viewable window 110. In this manner, as a user 114 scrolls through the rows of multiple cards, the card view module 108 creates and renders the card view just for those cards that will be visually displayed.

In one exemplary implementation, the binding mechanism used to virtually bind one subset of objects to another subset of objects in a row may be an attribute or field or other criteria that is common to each of the objects. More than one binding mechanism may be used.

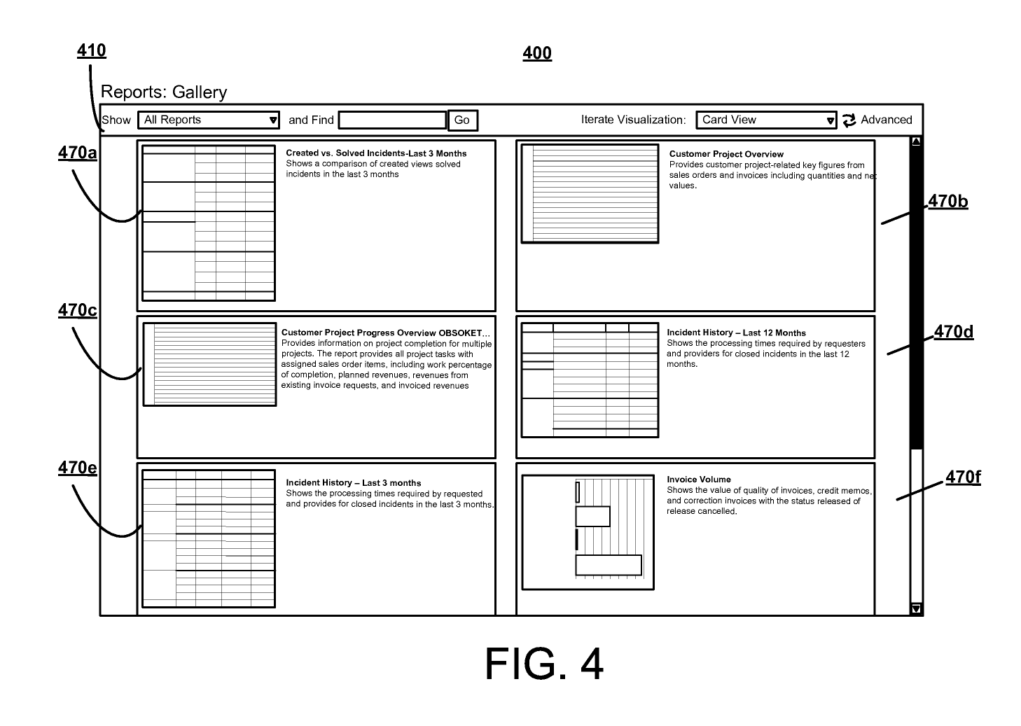

Referring to FIG. 4, an exemplary screen shot 400 illustrates one exemplary use case. Screen shot 400 illustrates a card view in a viewable window 410 with six cards 470a-470f. In this example, there are two cards displayed per row (i.e., 470a and 470b, 470c and 470d, 470e and 470f), where each of the cards represents an object from a linear table that has been transformed into a virtual intermediate row-level objects with one subset of the objects bound to the other subset of objects. In this example, each object and displayed card is a report and the report may be a read-only report.

As discussed above, each of the cards in the second column 470b, 470d, and 470f is linked to one of the cards in the first column 470a, 470c, and 470e, respectively, using a binding mechanism. In this example, the binding mechanism may be one of the fields in the report or an index field or an identifier field. The binding mechanism may or may not be displayed on the cards. In one example, the binding mechanism may be a hidden attribute that is common to each of the cards.

A selection of one of the cards (e.g., a selection of one of the reports) 470a-470f may provide access to additional or other information related to the report. For example, a selection of one of the cards of one of the reports may cause another window to open, where the other window includes additional or other information related to the selected card view.

In this example, other actions may be performed on each of the cards 470a-470f. For instance, each of the cards 470a-470f may be expanded and/or collapsed. Alternatively, an expansion or collapse of one of the cards in a same row, such as a selection of card 470a, may cause both cards in the same row 470a and 470b to both expand or collapse.

The number of cards displayed in a row in the viewable window 410 may be based on a size of the viewable window and a size of the cards. For example, if the viewable window 410 is made smaller by input from a user, then the card view may dynamically change to a single card per row. As discussed above, the card view module 108 may generate and render the card view in real time or substantially real time for only the cards to be displayed in the viewable window 410. When the viewable window 410 is resized, the card view module 108 re-generate and re-render the card view to display cards per row that will fit in the re-sized viewable window.

In one exemplary implementation, one of the cards 470a-470f that is in focus in the viewable window 410 may be an anchor object. The anchor object may be the primary object (e.g., an object in the first column of displayed cards) of a currently selected visible card. When the card view structure is changed, for example when the viewable window is resized, the card view brings the anchor object and its row of cards, which may be referred to as an anchor row, into the viewable window. In this manner, the user context and the focus does not change and remains consistent when the card view structure is changed.

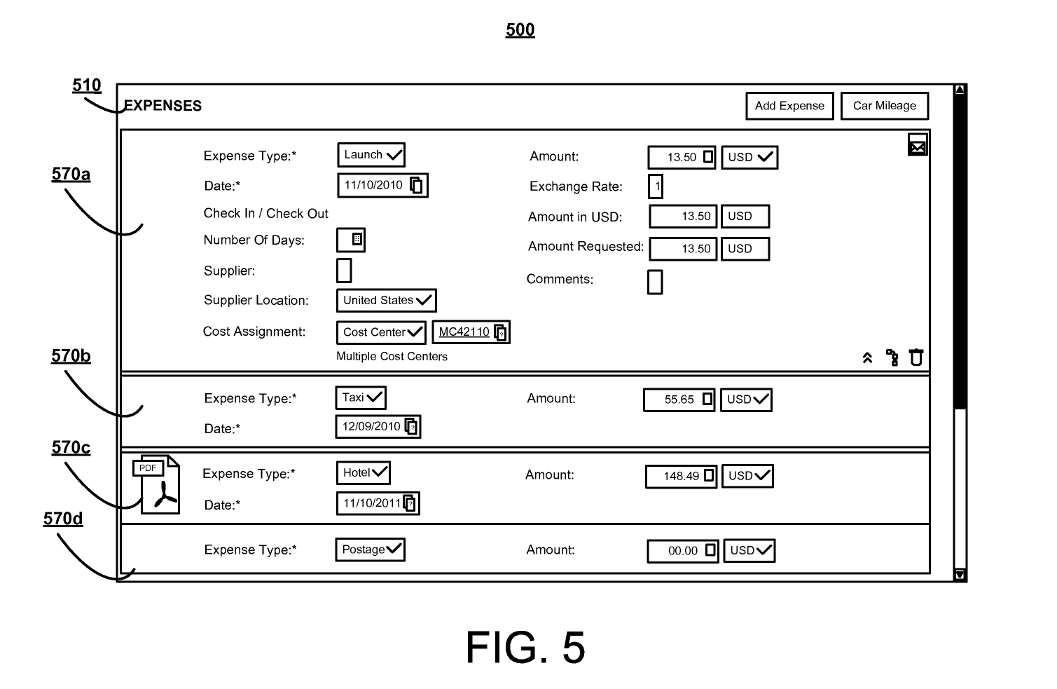

Referring to FIG. 5, an exemplary screen shot 500 illustrates one exemplary use case. In this example, the viewable window 510 includes four cards 570a-570d in a single column. In this example, there is one card 570a-570d displayed per row, where each of the cards represents an object from a linear table that has been transformed into a virtual intermediate row-level objects with one subset of the objects. The subset of the objects are not bound to any other subset of objects because only a single row is capable of being displayed in the viewable window 510 based on the size of the viewable window 501 and a size of the cards 570a-570d.

In this example, each object and displayed card is an editable expense form, where each of the forms may be edited. A user may input values or select options from the different fields in the expense form. All of the fields and layout of the card may have been pre-defined by a designer through the pane modeller module 105 of FIG. 1. When a user edits the data in the forms, only the changed data may be communicated to a backend application instead of communicating and sending all of the data from the forms to the backend application.

The number of cards displayed in a row in the viewable window 510 may be based on a size of the viewable window and a size of the cards. For example, if the viewable window 510 is made larger by input from a user, then the card view may dynamically change to multiple cards per row. As discussed above, the card view module 108 may generate and render the card view in real time or substantially real time for only the cards to be displayed in the viewable window 510. When the viewable window 510 is resized, the card view module 108 re-generate and re-render the card view to display cards per row that will fit in the re-sized viewable window 510.

Also, in one exemplary implementation, one of the cards 570a-570d that is in focus in the viewable window 510 may be an anchor object. The anchor object may be the primary object (e.g., an object in the first column of displayed cards) of a currently selected visible card. When the card view structure is changed, for example when the viewable window is resized, the card view brings the anchor object and its row of cards, which may be referred to as an anchor row, into the viewable window. In this manner, the user context and the focus does not change and remains consistent when the card view structure is changed.

Referring back to FIG. 1, the system 100 may include at least one storage device 116 and at least one processor 118. The storage device 116 and the processor 118 may be connected to or operably coupled to, either physically or logically, all of the components illustrated in FIG. 1. The storage device 116 may be any type of storage device or memory module or multiple memory modules that are used to store instructions for processing by the processor 118. The storage device 116 may include RAM, ROM, or any other type of storage device. The storage device 116 may be a non-transitory computer-readable storage medium. The processor 118 may be configured to execute the instructions on the storage device 116 and cause the other components illustrated in FIG. 1 to perform one or more various actions as described throughout this document.

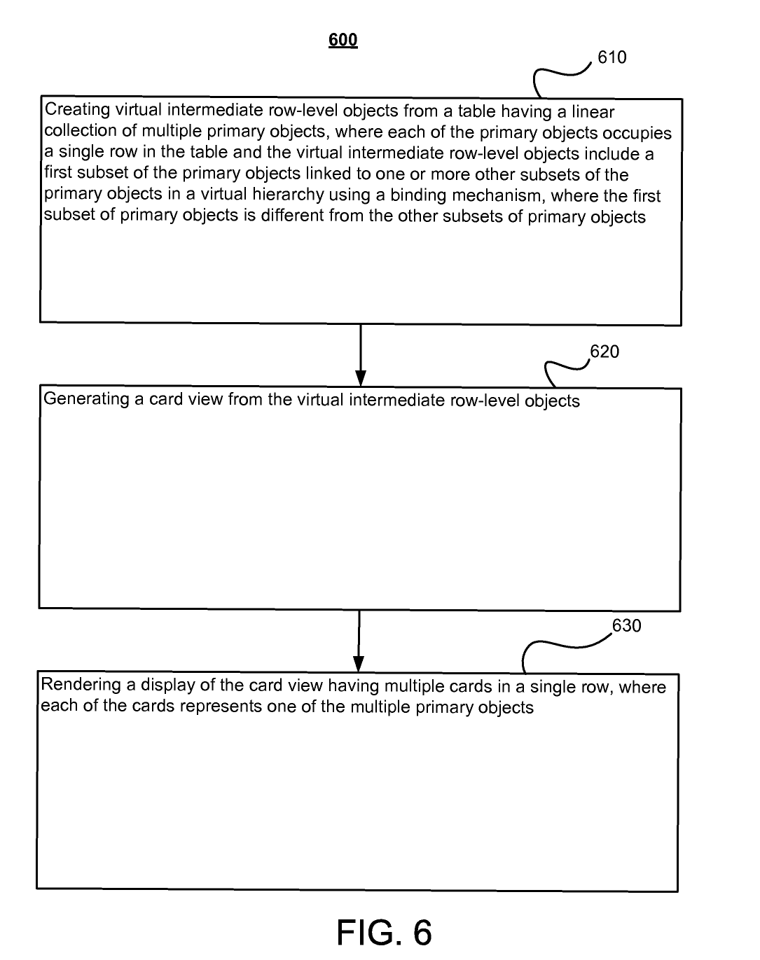

Referring to FIG. 6, an exemplary flowchart illustrates a process 600 for implementing the system 100 of FIG. 1. Process 600 includes creating virtual intermediate row-level objects from a table having a linear collection of multiple primary objects, where each of the primary objects occupies a single row in the table and the virtual intermediate row-level objects include a first subset of the primary objects linked to one or more other subsets of the primary objects in a virtual hierarchy using a binding mechanism (610). For example, as discussed above, the table control module 106 may be configured to create virtual intermediate row-level objects from a table having a linear collection of multiple primary objects, where each of the primary objects occupies a single row in the table and the virtual intermediate row-level objects include a first subset of the primary objects linked to one or more other subsets of the primary objects in a virtual hierarchy using a binding mechanism (610). As illustrated above in FIGS. 2 and 3, the table control module 106 may create the virtual intermediate row-level objects 350 from the linear table of objects 200.

Process 600 includes generating a card view from the virtual intermediate row-level objects (620). For example, the card view module 108 of FIG. 1 may be configured to generate a card view from the virtual intermediate row-level objects (620). Process 600 includes rendering a display of the card view having multiple cards in a single row, where each of the cards represents one of the multiple primary objects (630). For example, the card view module 108 is configured to render a display of the card view having multiple cards in a single row (630). As discussed above, as a viewable window in which the card view is displayed is changed (e.g., re-sized), the card view module 108 is configured to re-create the card view and re-render the display of the card view with a number of cards in a row that will fit in the viewable window based on the size of the re-sized viewable window and the size of the card.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer system comprising:
at least one processor; and
a non-transitory computer-readable storage medium including instructions executable by the at least one processor, the instructions configured to implement:
a table having a linear collection of multiple primary objects, wherein each of the primary objects occupies a single row in the table;
a table control module configured to create virtual intermediate row-level objects from the linear collection of multiple primary objects, the virtual intermediate row-level objects including a first subset of the primary objects linked to one or more other subsets of the primary objects in a virtual hierarchy using a binding mechanism, wherein the first subset of primary objects is different from the other subsets of primary objects; and
a card view module configured to generate a card view from the virtual intermediate row-level objects and to render a display of the card view having multiple cards in a single row, wherein each of the cards represents one of the multiple primary objects.

2. The computer system of claim 1 wherein the card view module is configured to generate the card view and to render the display of the card view of only the cards capable of being displayed in a viewable window.

3. The computer system of claim 1 wherein the card view module is configured to generate the card view and to render the display of the card view of multiple cards in a single row based on a size of a viewable window and a size of the cards.

4. The computer system of claim 1 wherein the card view module is configured to dynamically change a number of the cards displayed in the single row based on a resizing of a viewable window.

5. The computer system of claim 1 wherein the binding mechanism comprises a field common to each of the primary objects.

6. The computer system of claim 1 wherein the card view is user-configurable.

7. The computer system of claim 1 wherein each of the cards includes a form and only data entered into a form is communicated to a backend application.

8. The computer system of claim 1 wherein one of the cards in focus in a viewable window is an anchor object and the card view module is configured to dynamically change a number of the cards displayed in the single row based on a resizing of the viewable window and to maintain the card that is the anchor object in focus after resizing.

9. The computer system of claim 1 wherein each of the cards includes at least one of a custom user interface, a modeled pane and a combination of a custom user interface and a modeled pane.

10. A non-transitory computer-readable storage medium storing instructions that when executed cause a processor to perform a process, the instructions comprising instructions to:
create virtual intermediate row-level objects from a table having a linear collection of multiple primary objects, wherein each of the primary objects occupies a single row in the table and the virtual intermediate row-level objects include a first subset of the primary objects linked to one or more other subsets of the primary objects in a virtual hierarchy using a binding mechanism, wherein the first subset of primary objects is different from the other subsets of primary objects;
generate a card view from the virtual intermediate row-level objects; and
render a display of the card view having multiple cards in a single row, wherein each of the cards represents one of the multiple primary objects.

11. The non-transitory computer-readable storage medium of claim 10 wherein the instructions to render the display of the card view comprise instructions to render the card view of only the cards capable of being displayed in a viewable window.

12. The non-transitory computer-readable storage medium of claim 10 wherein the instructions to render the display of the card view comprise instructions to render the display of the card view of multiple cards in a single row based on a size of a viewable window and a size of the cards.

13. The non-transitory computer-readable storage medium of claim 10 further comprising instructions to dynamically change a number of the cards displayed in the single row based on a resizing of a viewable window.

14. The non-transitory computer-readable storage medium of claim 10 wherein the binding mechanism comprises a field common to each of the primary objects.

15. The non-transitory computer-readable storage medium of claim 10 wherein each of the cards includes a form and only data entered into a form is communicated to backend application.

16. The non-transitory computer-readable storage medium of claim 10 wherein one of the cards in focus in a viewable window is an anchor object and the instructions further comprise instructions to dynamically change a number of the cards displayed in the single row based on a resizing of the viewable window and to maintain the card that is the anchor object in focus after resizing.

17. A method including executing instructions recorded on a non-transitory computer-readable storage media using at least one processor, the method comprising:
creating virtual intermediate row-level objects from a table having a linear collection of multiple primary objects, wherein each of the primary objects occupies a single row in the table and the virtual intermediate row-level objects include a first subset of the primary objects linked to one or more other subsets of the primary objects in a virtual hierarchy using a binding mechanism, wherein the first subset of primary objects is different from the other subsets of primary objects;
generating a card view from the virtual intermediate row-level objects; and
rendering a display of the card view having multiple cards in a single row, wherein each of the cards represents one of the multiple primary objects.

18. The method as in claim 17 wherein rendering the display of the card view comprises rendering the display of the card view of only the cards capable of being displayed in a viewable window.

19. The method as in claim 17 wherein rendering the display of the card view comprises rendering the display of the card view of multiple cards in a single row based on a size of the viewable window and a size of the cards.

20. The method as in claim 17 further comprising dynamically changing a number of cards displayed in the single row based on a resizing of a viewable window.
